(19) United States
(12) Patent Application Publication
(10) Pub. No.: US 2008/0291432 A1
(43) Pub. Date: Nov. 27, 2008

(54) SYSTEM AND METHOD FOR MONITORING THE COUPLING EFFICIENCY OF A FIBER-OPTIC SURGICAL SYSTEM

(76) Inventors: Christopher Horvath, Irvine, CA (US); Laszlo O. Romoda, San Clemente, CA (US)

Correspondence Address: ALCON, IP LEGAL, TB4-8, 6201 SOUTH FREEWAY, FORT WORTH, TX, 76134, US

(21) Appl. No.: 12/109,955

(22) Filed: Apr. 25, 2008

Related U.S. Application Data
(60) Provisional application No. 60/914,237, filed on Apr. 26, 2007.

(51) Int. Cl. G01N 21/01

(52) U.S. Cl. 356/73.1

(57) ABSTRACT

Embodiments of the present invention provide a system and method for allowing a user to monitor the coupling efficiency of a fiber-optic surgical system. An embodiment of the present invention can include: an energy source to produce a beam of light, a fiber in optical communication with the energy source and a set of light sensors positioned to detect scattered light from the beam of light scattered proximate to the entrance of the fiber.

### CROSS-REFERENCE TO RELATED APPLICATIONS

This application claims priority under 35 U.S.C. §119 to U.S. Provisional Patent Application No. 60/914,237 filed Apr. 26, 2007, the entire contents of which are incorporated herein by reference.

### TECHNICAL FIELD OF THE INVENTION

The present invention relates to surgical procedures. More particularly, embodiments of the present invention relate to energy propagation in a fiber-optic surgical system. Even more particularly, embodiments of the present invention relate to systems and methods for assessing the coupling efficiency of an energy source to a fiber-optic fiber.

### BACKGROUND

The human eye can suffer a number of maladies causing mild deterioration to complete loss of vision. Though contact lenses and eyeglasses are commonly used for vision correction, surgery can also be used for vision correction.

One type of surgical system used for eye surgery can comprise an energy source generating a laser beam which is coupled to a narrow-gauge fiber-optic fiber. The narrow-gauge fiber may be inserted into an eye to provide photocoagulation at a surgical site. An example of such a surgical system is the Eyelite® Photocoagulator System manufactured by Alcon Laboratories, Inc., of Fort Worth, Tex. Similar systems and laser surgery techniques can also be used in other forms of surgery. In another surgical application, a fiber may be coupled to an illumination source and used to provide illumination at a surgical site.

Some fiber-optic surgical systems couple a fiber to an energy source through the use of a fiber port. Fiber ports may allow individual fibers to be easily removed and replaced. To ensure that a laser beam or other energy source is coupled to the fiber so as to minimize power loss and maximize throughput, the coupling of the fiber to the energy source is calibrated. Internal sensors, e.g. one or more photodiodes, measure power leakage. Through the use of internal sensors, an accurate measurement of the power transferred to the fiber can be ascertained. However, existing systems of internal monitoring do not monitor coupling losses at the fiber port to fiber juncture or connection to fiber juncture with internal sensors.

Calibration to account for energy losses including coupling inefficiencies is done, for example, by coupling a fiber to a fiber port or connection receiving an energy (e.g., lighted) beam from an energy source and measuring the power of the beam or energy component at a fiber distal end with an external calibrated power meter or other measurement device. Typically this calibration is done as part of manufacture or is done at installation. In some surgical systems, the surgical system is placed in service mode and various fibers with various throughputs are measured and compared against ideal throughputs to ascertain the coupling efficiency of the fibers to the fiber port or connection.

After the calibration of the coupling of the fiber to the fiber port or other connection at manufacture or installation, there is no way to verify the continuing calibration of the coupling of the fiber to the fiber port or other connection without repeating the above process. As the coupling of the fiber to the fiber port or other connection may degrade over time or through use, it may be necessary to re-calibrate the coupling or confirm the calibration of the coupling of the fiber to the fiber port or other connection. Often the calibration of the coupling of the fiber to the fiber port or other connection is carried out by a technician or other specialist. In such cases, the degradation and loss of calibration will not be noticed until the technician calibrates the coupling of the fiber to the fiber port or other connection.

### SUMMARY OF THE INVENTION

Embodiments of the present invention provide a method and system for monitoring the coupling of a fiber to a fiber port, or other connection, which are substantially more continuous and user-friendly than prior art methods and systems of monitoring coupling. One embodiment of the present invention includes a method for monitoring coupling efficiency. The method can comprise the steps of: directing a beam of light to a fiber, detecting scattered light from the beam of light scattered proximate to an entrance of the fiber using a set of light sensors, and determining the coupling efficiency based on one or more signals generated by the set of light sensors. The method can also comprise outputting data representative of the measured coupling efficiency to a user. The method can further comprise adjusting the alignment of the beam of light or increasing the power of the beam of light.

Another embodiment of the invention can include an apparatus for monitoring coupling efficiency. The apparatus can comprise: an energy source to produce a beam of light, a fiber in optical communication with the energy source, and a set of light sensors positioned to detect scattered light from the beam of light scattered proximate to the entrance of the fiber. The apparatus can also comprise an output device operable to output data to a user, e.g. a display. The apparatus can further comprise an active optics mount operable to align the beam of light. The apparatus can include a controller.

The present invention provides advantages over the prior art in that the coupling efficiency and calibration of the coupling of an energy source to a fiber core can be continually monitored. Embodiments of the present invention allow a surgical system to compensate for a loss in coupling efficiency such that a desired energy is propagated to a surgical site. The invention has the further advantage that the above advantages can be realized without recourse to service calls.

### BRIEF DESCRIPTION OF THE FIGURES

A more complete understanding of the present invention and the advantages thereof may be acquired by referring to the following description, taken in conjunction with the accompanying drawings in which like reference numbers indicate like features and wherein:

FIG. 1 is a diagrammatic representation of one embodiment of a fiber-optic fiber in accordance with the teachings of the present invention;

FIG. 2 is a diagrammatic representation of one embodiment of a surgical system in accordance with the teachings of the present invention;

FIG. 3 is a diagrammatic representation of one embodiment of the light sensors of the present invention;

FIGS. 4a-e are diagrammatic representations of embodiments of the present invention; and

FIG. 5 is a block diagram of one embodiment of a controller which could be used with embodiments of the present invention.

### DETAILED DESCRIPTION

Preferred embodiments of the invention are illustrated in the FIGURES, like numerals being used to refer to like and corresponding parts of the various drawings.

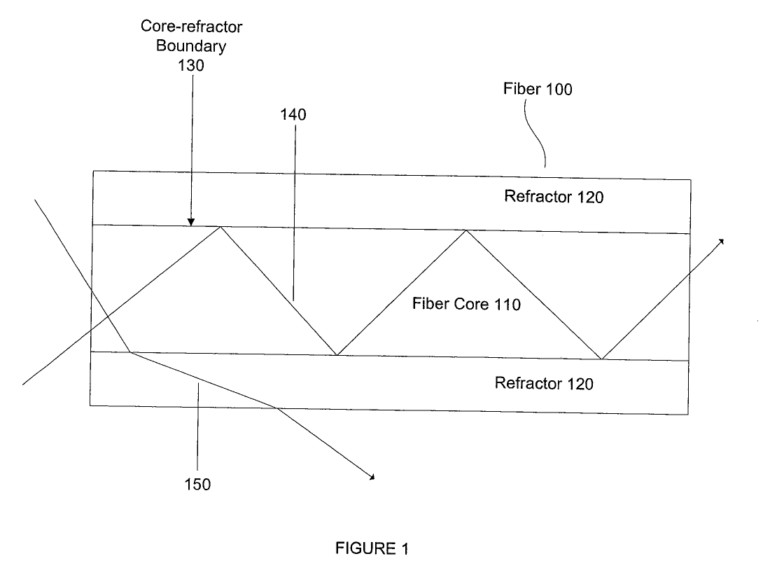

FIG. 1 is a diagrammatic representation of one embodiment of a fiber-optic fiber 100 in accordance with the teachings of this invention. Fiber-optic fiber 100 comprises a fiber core 110 which is surrounded by a refractor 120. In other embodiments of a fiber 100, the fiber core 110 may be surrounded by a cladding. Light rays that meet core-refractor boundary 130 at an angle greater than the critical angle for the boundary 130 are reflected back into the fiber core 110 and thus propagate through the fiber core 110 to a destination (e.g., ray 140). Light rays that meet core-refractor boundary 130 at an angle less than the critical angle are refracted into refractor 120 and are not propagated to the destination (e.g., ray 150). The critical angle and other factors determine the acceptance angle or numerical aperture (NA) of a fiber. For a laser beam (or other light beam) to be optimally coupled to a fiber 100 so as to be propagated through the core, the laser beam must be coupled to the core at an angle within the NA of the fiber 100. Different fibers 100 may have different NAs.

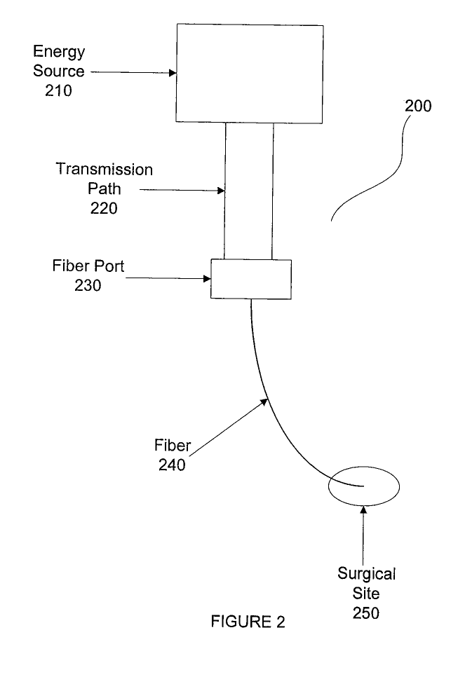

FIG. 2 is a diagrammatic representation of one embodiment of a surgical system 200 in accordance with the teachings of the present invention. In surgical system 200, energy source 210 is coupled to fiber-optic fiber 240 via transmission path 220 and fiber port 230 such that fiber 240 is in optical communication with energy source 210 to deliver a beam from energy source 210 to a surgical site 250. Embodiments of surgical system 200 can be used to perform photocoagulation at surgical site 250. In such embodiments, energy source 210 could be a laser. Other embodiments of surgical system 200 can be used for different surgical procedures or illumination at a surgical site 250.

To help maintain the sterility of surgical site 250, fiber 240 may be a disposable fiber which can be decoupled or removed from surgical system 200 and disposed of after use. In preparation for a new surgical procedure, a new, sterile fiber 240 may be coupled to energy source 210. The new, sterile fiber 240 may then be used, for example, to photocoagulate surgical site 250 as part of the performance of a surgical procedure. Different types of fibers 240 can be used for different surgical applications. For example, a very narrow-gauge fiber 240 can be chosen to minimize intrusion. For other applications, a wider-gauge fiber 240 may be selected to maximize photocoagulation. Different fibers 240 can be selected based upon flexibility, energy transmission or reflectivity.

Embodiments of the present invention measure the calibration or coupling efficiency of a laser or other energy source 210 into a fiber 240 through the use of a sensor array which includes a set of light sensors. The set of light sensors can be arranged in a ring that encircles the coupling of a fiber 240 to a fiber port or other connection. The light sensors detect scattered light. The more scattered light that is detected by the set of energy (e.g., light) sensors, the poorer the coupling efficiency of the fiber 240 to the fiber port or other connection. To detect scattered light, the light sensors must be sensitive to the wavelength of light produced by the laser or other energy source. The greater the number of light sensors, the finer the resolution in the detection of scattered light.

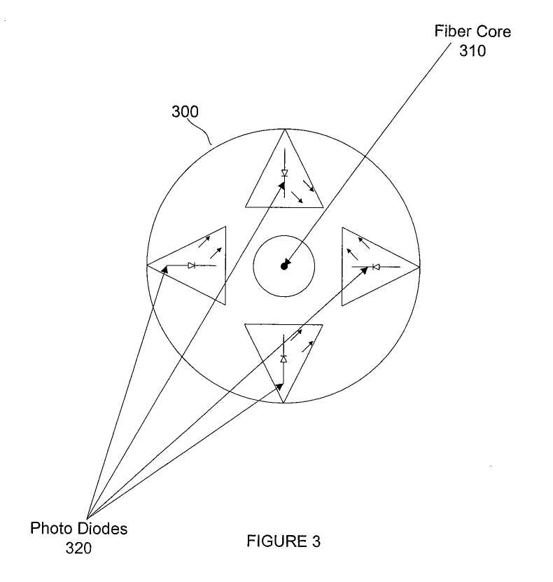

FIG. 3 is a diagrammatic representation of a vertical view of one embodiment of a light sensor array of the present invention. Sensor array 300 encircles fiber core 310. Sensor array 300 detects light scattered from fiber core 310 with a set of light sensors 320. The light sensors 320 can be any sensor that can indicate the presence of scattered light. Preferably, the light sensors 320 are photodiodes, such as photodiodes (sensors) 320 shown in FIG. 2. Photodiodes 320 are arranged in a circle around fiber core 310. In this embodiment of the invention, photodiodes 320 are four diodes. In other embodiments of the invention, the number of photodiodes 320 used can be different, for example, three or more. In this embodiment of the invention, photodiodes 320 are arranged in a ring in the same plane. However, other embodiments of the invention can comprise photodiodes 320 arranged so that they are not in the same plane.

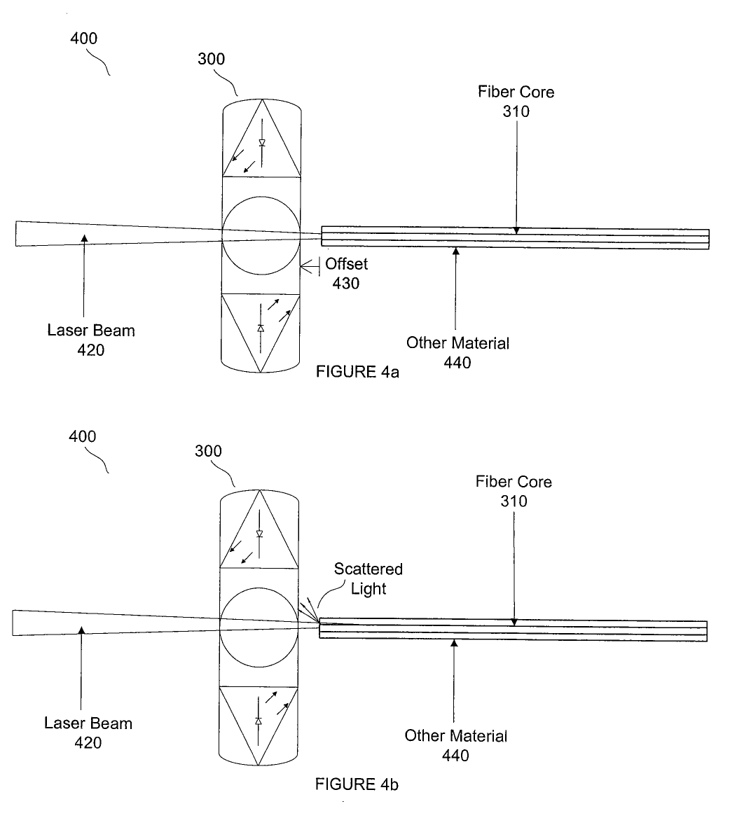

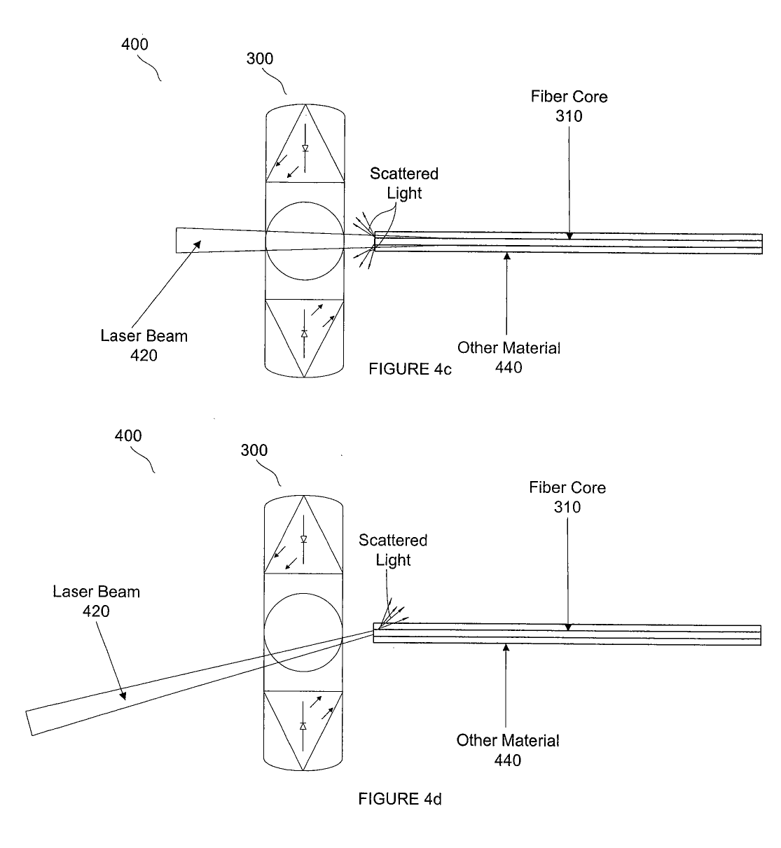

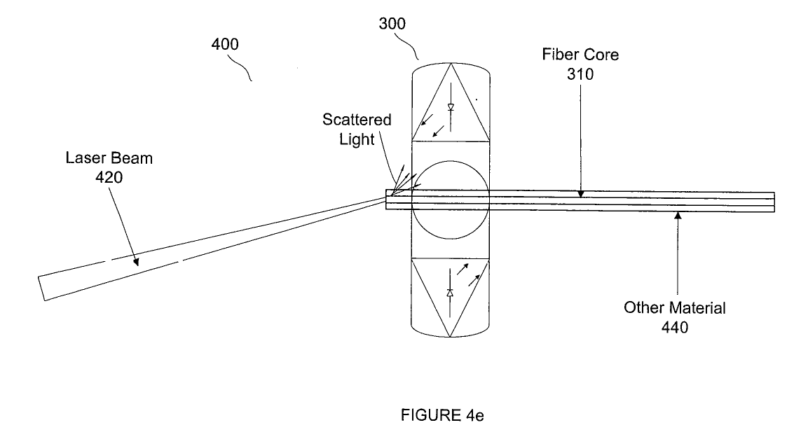

FIGS. 4a-4e are diagrammatic representations of embodiments of the present invention. In system 400 of FIG. 4a, laser beam 420 is coupled to fiber core 310, which can be encased in other material 440. Sensor array 300 encircles a longitudinal axis extending from fiber core 310 and is offset from the entrance of fiber core 310 by offset 430. By way of example, but not limitation, offset 430 can be in the range of 0-20 mm. Sensor array 300 is positioned to receive light backscattered due to coupling misalignment. Offset 430 may be along the longitudinal axis of fiber core 310 to enhance detection of light refracted or scattered by other material 440 or may be along the axis of laser beam 420 to enhance detection of light reflected or scattered by other material 440.

In the embodiment of FIG. 4a, the coupling of laser beam 420 to fiber core 310 shown is good: laser beam 420 is focused so that the center of laser beam 420 is aligned with the center of fiber core 310, to a diameter equal to or smaller than the diameter of fiber core 310, and within the acceptance angle of fiber core 310. Because the coupling of laser beam 420 to fiber core 310 is good, there is negligible scattered light for sensor array 300 to detect.

In FIG. 4b, laser beam 420 is shown laterally misaligned with fiber core 310. As can be seen from the representation, light from laser beam 420 is scattered by other material 440. In this example, the scattered light is reflected away from fiber core 310/other material 440. Sensor array 300 detects the scattered light. The greater the misalignment of laser beam 420 with fiber core 310, the poorer the coupling and the greater the amount of scattered light. Thus sensor array 300 will be able to detect the relative magnitude of the misalignment and the coupling efficiency of laser beam 420 with fiber core 310. As can be seen from FIG. 4b, an offset can enhance the detection of scattered light by sensor array 300.

In FIG. 4c, laser beam 420 is longitudinally misaligned with fiber core 310. That is, a laser beam 420 of a diameter greater than the diameter of fiber core 310 is focused at the entrance to fiber core 310. This results in light intersecting other material 440 such that a percentage of light from laser beam 420 is scattered and consequently is not coupled into fiber core 310. Such longitudinal misalignment reduces coupling efficiency. The greater the longitudinal misalignment, the greater the disparity between the diameter of laser beam 420 and the diameter of fiber core 310 at the coupling of laser beam 420 at the entrance to fiber core 310. The greater the disparity in diameters, the greater the percentage of the light from laser beam 420 that intersects other material 440 and is scattered instead of being coupled into fiber core 310. Thus sensor array 300 may be able to detect the relative magnitude of the misalignment and the coupling efficiency of laser beam 420 with fiber core 310. As can be seen from FIG. 4c, an offset 430 can enhance the detection of scattered light by sensor array 300.

In FIG. 4d, laser beam 420 is misaligned with fiber core 310 such that laser beam 420 intersects fiber core 310 at an angle. In some embodiments of the invention, other material 440 is a refractor capable of transmitting light. In such embodiments, if light from laser beam 420 intersects the boundary between fiber core 310 and other material 440 at an angle outside of the NA of the fiber, then instead of being reflected through fiber core 310, that light will be refracted through other material 440 and will not properly couple into fiber core 310. As shown in FIG. 4d, in this type of misalignment, light may be scattered forward along the axis of fiber core 310. In FIG. 4d, sensor array 300 is offset along the axis of laser beam 420 and so is not well placed to detect the forward scattered light.

In FIG. 4e, as in FIG. 4d, laser beam 420 is misaligned with fiber core 310 such that laser beam 420 intersects fiber core 310 at an angle. Sensor array 300 is offset along the axis of fiber core 310 in the direction of fiber core 310 so that it encircles fiber core 310 a set distance from the entrance to fiber core 310. This offset enhances the ability of sensor array 300 to detect forward scattered light. As is apparent from a comparison of FIG. 4d with FIG. 4e, offsets can be selected which heighten the ability of sensor 300 to detect scattered light from different types of misalignment.

In some embodiments of the invention, the offset may allow a sensor array to detect scattered light from a variety of misalignments. In some embodiments of the invention, it may be possible to use staggered sensors or multiple rings of sensors to detect scattered light and eliminate the need to choose a single offset.

Coupling efficiency is determined based on signals from one or more sensors of sensor array 300. In one embodiment of the invention, signals from all the sensors are added together. This sum can give a good representation of the coupling efficiency. The greater the amount of scattered light, the poorer the coupling, the larger the signal and the greater the actual lost energy. Depending on the type of misalignment, there may be a linear or polynomial relationship between actual lost energy and the signal from one or more sensors.

In other embodiments of the invention, signals from individual sensors are analyzed. Such a methodology can be used to ascertain the type of misalignment. Analyzing signals from individual sensors can allow a measurement system to determine the axis along which misalignment occurs. It is possible to analyze misalignment using both the sum of signals from one or more sensors and signals from individual sensors. For example, if sensors to one side of the fiber core detect more scattered light than sensors on the other side of the fiber core, this may indicate that the laser beam is laterally misaligned to that side, as in FIG. 4b.

Signals or data from embodiments of the present invention can be used to adjust the power of a laser beam to factor in power loss due to coupling inefficiencies such that a desired energy will be delivered to a surgical site. For example, if signal(s) from sensor array 300 indicate that the coupling inefficiency is fifteen percent, the power of the laser could be increased by fifteen percent, so that the surgical site receives the desired energy. This could be accomplished by a feedback loop or by a user. In embodiments of the present invention, data or signals obtained from the photodiodes can be compared to known control data to determine the type of misalignment and the likely coupling efficiency for different fiber types.

In one embodiment of the invention, the surgical system includes an active optics mount which can adjust the coupling of laser beam 420 into fiber core 310. The active optics mount can adjust the coupling in accordance with data based on signals from one or more sensors of sensor array 300. The active optics mount can be computer-controlled. In a further embodiment of the invention, the active optics mount and data based on signals from one or more sensors could be used to form a feedback loop which can be used to maintain the coupling of a laser beam to a fiber core.

The use of a sensor array to monitor the coupling efficiency of a fiber to a fiber port or other connection enables a user to monitor the calibration of a fiber-optic surgical system. The coupling efficiency or calibration can be output to a user on a display. In one embodiment of the invention, the user can then modify the power emitted by the energy source to compensate for lost energy. In other embodiments of the invention, if the coupling efficiency falls below a specified threshold, the user can be notified, for example, by a notification on a screen, or a warning signal such as a light or audio output. It is also possible for the surgical apparatus to be automatically shut off if coupling efficiency falls below a specified threshold.

In embodiments of a surgical system, different types of fibers, i.e. fibers with different NAs, refractions, core diameters, etc., will scatter light differently when in different alignments. Thus each type of fiber may scatter light according to a particular signature profile depending upon the misalignment of the fiber. Thus, it may be desirable to maintain a library of such signature profiles to aid in the determination of the type of misalignment. Such signature profiles could be maintained in, for example, a computer memory or other computer readable medium.

A library of signature profiles for different types of misalignment can be developed, for example, by placing various known fibers in various known misalignments and measuring the resultant signature profiles. In addition, a power meter can be used to measure the power output of the various known fibers in the various known misalignments. The power output can be correlated with the signature profiles and used to determine coupling efficiencies for individual signature profiles.

Embodiments of the present invention can include a controller or a computer. The controller or computer can control a feedback loop, adjust an active optical mount or process signals from one or more sensors. The controller or computer could further operate or control I/O devices, such as a user display. In other embodiments of the invention, the above functions could be implemented in hardware. For example, the sum of signals from the sensors of the sensor array of the present invention could be used to scale a meter or other user-viewable output device.

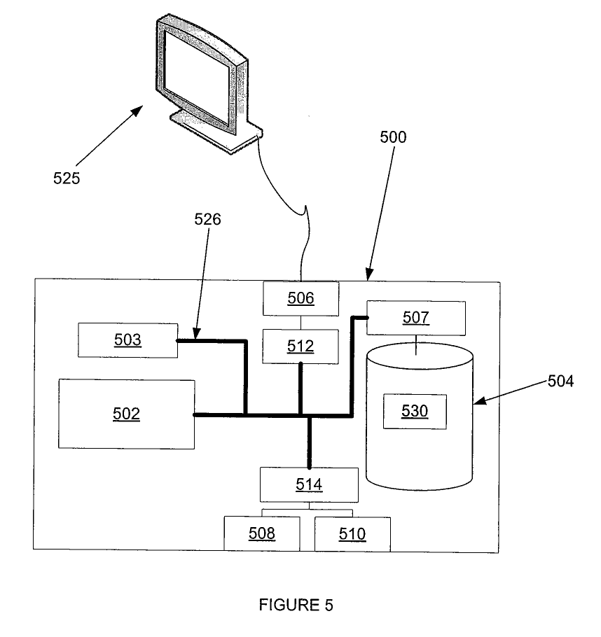

FIG. 5 is a diagrammatic representation of a controller 500 of some embodiments of the present invention. Controller 500 can be integrated into or connected to a surgical system incorporating an embodiment of the present invention. Controller 500 can include a processor 502, such as an Intel Pentium 4 based processor (Intel and Pentium are trademarks of Intel Corporation of Santa Clara, Calif.), a primary memory 503 (e.g., RAM, ROM, flash memory, EEPROM or other computer readable medium known in the art) and a secondary memory 504 (e.g., a hard drive, disk drive, optical drive or other computer readable medium known in the art). A memory controller 507 can control access to secondary memory 504. Controller 500 can include I/O interfaces, such as display interface 506. A video controller 512 can control interactions over display interface 506. Similarly, an I/O controller 514 can control interactions over I/O interfaces 508 and 510. I/O interfaces 508 and 510 may receive data or signals or output data or signals. For example, I/O interface 508 may receive data or signals from embodiments of the present invention. For example, I/O interface 510 may output data or signals to an active optics mount. Various components of controller 500 can be connected by a bus 526.

Secondary memory 504 can store a variety of computer instructions that include, for example, an operating system such as a Windows operating system (Windows is a trademark of Redmond, Wash. based Microsoft Corporation) and applications that run on the operating system, along with a variety of data. More particularly, secondary memory 504 can store a software program 530 that analyzes and outputs data and measurements taken by a sensor array (such as sensor array 300 of FIG. 3) that includes light sensors. During execution by processor 502, portions of program 530 can be stored in secondary memory 504 and/or primary memory 503.

In operation, program 530 can be executable by processor 502 to provide data to the user (e.g., through monitor 525) that is indicative of the calibration or coupling efficiency of a laser beam or other energy source to a fiber core. Thus, the controller can display representations of collected data to allow a user to determine the calibration of the coupling of a fiber to an energy source.

Controller 500 of FIG. 5 is provided by way of example only and it should be understood that embodiments of the present invention can be implemented as a set of computer executable instructions stored on a computer readable medium in a variety of computing devices. Program 530 can be executable to receive and store data over a network and can include instructions that are stored at a number of different locations and are executed in a distributed manner. While shown as a stand alone program in FIG. 5, it should be noted that program 530 can be a module of a larger program, can comprise separate programs operable to communicate data to each other or can be implemented according to any suitable programming architecture and language.

Although the present invention has been described in detail herein with reference to the illustrated embodiments, it should be understood that the description is by way of example only and is not to be construed in a limiting sense. It is to be further understood, therefore, that numerous changes in the details of the embodiment of this invention and additional embodiments of this invention will be apparent, and may be made by, persons of ordinary skill in the art having reference to this description. It is contemplated that all such changes and additional embodiments are within scope of the invention as claimed below.

What is claimed is:

1. A method, comprising:
directing a beam of light to a fiber;
detecting scattered light from the beam of light scattered proximate to an entrance of the fiber using a set of light sensors; and
determining the coupling efficiency based on one or more signals generated by the set of light sensors.

2. The method of claim 1, further comprising summing the one or more signals from the set of light sensors.

3. The method of claim 1, wherein the set of light sensors comprise three or more photodiodes.

4. The method of claim 3, wherein the photodiodes are arranged around a path of the beam of light.

5. The method of claim 4, wherein the photodiodes are arranged in one or more circles.

6. The method of claim 3, wherein the photodiodes are offset from the entrance of the fiber.

7. The method of claim 1, further comprising increasing the power of the beam of light based on the coupling efficiency.

8. The method of claim 1, further comprising adjusting the alignment of the beam of light using an active optics mount based on the one or more signals from the set of light sensors.

9. The method of claim 1, further comprising outputting one or more items of data, the items of data based on the one or more signals from the set of light sensors.

10. The method of claim 1, further comprising detecting scattered light from the beam of light scattered due to lateral misalignment.

11. The method of claim 1, further comprising detecting scattered light from the beam of light scattered due to longitudinal misalignment.

12. The method of claim 1, further comprising detecting scattered light from the beam of light scattered due to a focus angle of the beam of light being outside an acceptance angle of the fiber.

13. An apparatus, comprising:
an energy source to produce a beam of light;
a fiber in optical communication with the energy source; and
a set of light sensors positioned to detect scattered light from the beam of light scattered proximate to the entrance of the fiber.

14. The apparatus of claim 13, wherein the light sensors are photodiodes.

15. The apparatus of claim 14, wherein the photodiodes are arranged around a path of the beam of light.

16. The apparatus of claim 15, wherein the photodiodes are arranged in one or more circles.

17. The apparatus of claim 14, wherein the photodiodes are offset from the entrance of the fiber.

18. The apparatus of claim 14, wherein the fiber is detachable.

19. The apparatus of claim 14, wherein the fiber is a surgical fiber.

20. The apparatus of claim 14, further comprising an active optics mount operable to align the beam of light based on signals from the photodiodes.

21. The apparatus of claim 14, further comprising an output operable to output data based on signals from the photodiodes to a user.

22. The apparatus of claim 14, further comprising a controller operable to: output data to a user; increase the power of the energy produced by the energy source; and adjust an active optics mount to align the beam of light based on signals from the photodiodes.

23. The apparatus of claim 13, wherein the set of light sensors comprise at least one light sensor located after the entrance of the fiber.

24. An apparatus, comprising:
an output device;
an energy source to produce a beam of light;
a fiber in optical communication with the energy source;
a set of photodiodes arranged around a path of the beam of light and positioned to detect scattered light from the beam of light scattered proximate to the entrance of the fiber; and
a controller, wherein the controller is coupled to the set of photodiodes and is operable to determine the coupling efficiency of the beam of light to the fiber and output the coupling efficiency to the output device.

25. The apparatus of claim 24, wherein the controller is further operable to increase the power of the energy produced by the energy source.

26. The apparatus of claim 24, wherein the output device is a display.

27. The apparatus of claim 24, wherein the set of photodiodes comprise photodiodes arranged in one or more rings.

28. The apparatus of claim 24, wherein the set of photodiodes comprise three or more photodiodes.

29. The apparatus of claim 24, wherein the set of photodiodes comprise at least one photodiode located after the entrance of the fiber.
